(19) United States
(12) Patent Application Publication
(10) Pub. No.: US 2026/0136303 A1
(43) Pub. Date: May 14, 2026

(54) MAXIMUM TRANSMIT POWER FOR WIRELESS PERSONAL AREA NETWORK COMMUNICATIONS IN NON-TERRESTRIAL NETWORK TIME RESOURCES

(71) Applicant: QUALCOMM Incorporated, San Diego, CA (US)

(72) Inventors: Yahia RAMADAN, San Jose, CA (US); Kamalakar GANTI, San Marcos, CA (US); Thawatt GOPAL, San Diego, CA (US)

(21) Appl. No.: 18/943,389

(22) Filed: Nov. 11, 2024

(51) Int. Cl. H04W 52/36; H04B 7/185; H04W 72/0446

(52) U.S. Cl. CPC H04W 52/367; H04B 7/18513; H04W 72/0446

(57) ABSTRACT

Various aspects of the present disclosure generally relate to wireless communication. In some aspects, a wireless communication device may transmit, in one or more non-terrestrial network (NTN) uplink transmission gap time resources, one or more wireless personal area network (WPAN) communications in accordance with a first maximum transmit power. The wireless communication device may transmit, in one or more NTN uplink transmission time resources, the one or more WPAN communications in accordance with a second maximum transmit power that is greater than the first maximum transmit power. Numerous other aspects are described.

### FIELD OF THE DISCLOSURE

Aspects of the present disclosure generally relate to wireless communication and specifically relate to techniques, apparatuses, and methods associated with a maximum transmit power for wireless personal area network communications in non-terrestrial networks time resources.

### BACKGROUND

Wireless communication systems are widely deployed to provide various types of communication content such as voice, video, packet data, messaging, broadcast, and so on. These systems may be multiple-access systems capable of supporting communication with multiple users by sharing the available system resources (for example, time, frequency, and power). A wireless network, for example a wireless local area network (WLAN), such as a Wi-Fi (for example, Institute of Electrical and Electronics Engineers (IEEE) 802.11) network, may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. “Downlink” may refer to the communication link from the AP to the station, and “uplink” may refer to the communication link from the station to the AP.

The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (for example, the communication link from the AP to the device) and uplink (for example, the communication link from the device to the AP). A wireless personal area network (WPAN), which may include a Bluetooth® connection, may provide for short range wireless connections between two or more paired wireless devices. For example, wireless devices such as cellular phones may utilize WPAN communications to exchange information such as audio signals with wireless headsets.

### SUMMARY

Some aspects described herein relate to an apparatus for wireless communication at a wireless communication device. The apparatus may include one or more memories and one or more processors coupled to the one or more memories. The one or more processors may be configured to cause the wireless communication device to transmit, in one or more non-terrestrial network (NTN) uplink transmission gap time resources, one or more wireless personal area network (WPAN) communications in accordance with a first maximum transmit power. The one or more processors may be configured to cause the wireless communication device to transmit, in one or more NTN uplink transmission time resources, the one or more WPAN communications in accordance with a second maximum transmit power that is greater than the first maximum transmit power.

Some aspects described herein relate to a method of wireless communication performed by a wireless communication device. The method may include transmitting, in one or more NTN uplink transmission gap time resources, one or more WPAN communications in accordance with a first maximum transmit power. The method may include transmitting, in one or more NTN uplink transmission time resources, the one or more WPAN communications in accordance with a second maximum transmit power that is greater than the first maximum transmit power.

Some aspects described herein relate to an apparatus for wireless communication. The apparatus may include means for transmitting, in one or more NTN uplink transmission gap time resources, one or more WPAN communications in accordance with a first maximum transmit power. The apparatus may include means for transmitting, in one or more NTN uplink transmission time resources, the one or more WPAN communications in accordance with a second maximum transmit power that is greater than the first maximum transmit power.

Some aspects described herein relate to a non-transitory computer-readable medium that stores a set of instructions for wireless communication by a wireless communication device. The set of instructions, when executed by one or more processors of the wireless communication device, may cause the wireless communication device to transmit, in one or more NTN uplink transmission gap time resources, one or more WPAN communications in accordance with a first maximum transmit power. The set of instructions, when executed by one or more processors of the wireless communication device, may cause the wireless communication device to transmit, in one or more NTN uplink transmission time resources, the one or more WPAN communications in accordance with a second maximum transmit power that is greater than the first maximum transmit power.

Aspects generally include a method, apparatus, system, computer program product, non-transitory computer-readable medium, an access point (AP), a station (STA), a mobile device, a peripheral device, an audio device, user equipment, base station, network entity, network node, wireless communication device, and/or processing system as substantially described herein with reference to and as illustrated by the drawings and specification.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (for example, end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (for example, hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 shows a wireless communication network, in accordance with the present disclosure.

FIG. 2 shows an example of a wireless communication network that supports low-latency parameter updates for extended personal audio networks, in accordance with the present disclosure.

FIG. 3 is a diagram illustrating an example of a wireless communication device, in accordance with the present disclosure.

FIG. 4 is a diagram illustrating an example of a regenerative satellite deployment and an example of a transparent satellite deployment in a non-terrestrial network (NTN).

FIG. 5 is a diagram illustrating an example associated with signaling to support wireless personal area network (WPAN) and NTN coexistence, in accordance with the present disclosure.

FIG. 6 is a diagram illustrating an example associated with a maximum transmit power limit, in accordance with the present disclosure.

FIG. 7 is a diagram illustrating an example associated with a flowchart for WPAN and NTN coexistence, in accordance with the present disclosure.

FIG. 8 is a diagram illustrating an example process performed, for example, at a wireless communication device or an apparatus of a wireless communication device, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Narrowband NTN (NB-NTN) is a type of NTN that is deployed over a limited range of frequencies. In some examples, a user equipment (UE) may access a NB-NTN using a NB-NTN radio on a wireless wide area network (WWAN) modem. For example, the UE may use the NB-NTN radio for emergency (e.g., “SOS”) services in cases where other WWAN radios are not available. In some examples, the UE May transmit one or more NB-NTN uplink data communications during a plurality of narrowband physical uplink shared channel (NPUSCH) time windows and monitor for one or more narrowband secondary synchronization signals (NSSSs) during gaps.

NB-NTN may operate in one or more frequency bands that are close to and/or overlap with a Bluetooth frequency band (e.g., 2.4 GHZ). As a result, Bluetooth communications received at the UE may act as an aggressor and/or jammer to the NSSS, which may result in uplink frequency error due to local oscillator drift. Accordingly, the UE may reduce a transmit power of Bluetooth communications while NB-NTN is awake in a connected mode discontinuous reception (CDRX) or awake in idle mode discontinuous reception (IDRX). For example, the UE may reduce the Bluetooth transmit power to a constant power level across all NPUSCH time windows and gaps.

However, the backoff may prevent successful communication over a Bluetooth link. For example, a user who is wearing a Bluetooth device may be in an accident that results in the UE being far away from the user; in such cases, the UE (e.g., a Bluetooth module of the UE) may be in a far cell condition such that the reduced transmit power is insufficient to enable the user to use a voice command to prompt the UE to send an emergency text message.

Various aspects relate generally to coexistence of Bluetooth and NB-NTN. Some aspects more specifically relate to permitting the UE to transmit Bluetooth communications up to a maximum transmit power of the UE during the NPUSCH time windows. In some aspects, the UE may transmit the Bluetooth communications up to the maximum transmit power of the UE during the NPUSCH time windows in cases where the NPUSCH time windows are longer than a time threshold. The UE may transmit Bluetooth communications up to a reduced maximum transmit power during the gaps.

Particular aspects of the subject matter described in this disclosure can be implemented to realize one or more of the following potential advantages. In some examples, the described techniques can be used to enable a larger Bluetooth communication range between the Bluetooth device and the UE. For example, if a user is wearing the Bluetooth device and is involved in an accident that results in the UE being far away from the user, then the UE may transmit a voice command to the Bluetooth device at up to the maximum transmit power of the UE (e.g., to enable the UE to send an emergency text message). The NPUSCH time windows being longer than a time threshold may help to ensure that the Bluetooth module of the UE has sufficient time to receive an indication of, and apply, a transmit power backoff reset.

Several aspects of wireless communication networks will now be presented with reference to various apparatuses and techniques. These apparatuses and techniques will be described in the following detailed description and illustrated in the accompanying drawings by various blocks, modules, components, circuits, steps, processes, and/or algorithms, among other examples (collectively referred to as “elements”). These elements may be implemented using hardware, software, or combinations thereof. Whether such elements are implemented as hardware or software depends upon the particular application and design constraints imposed on the overall system.

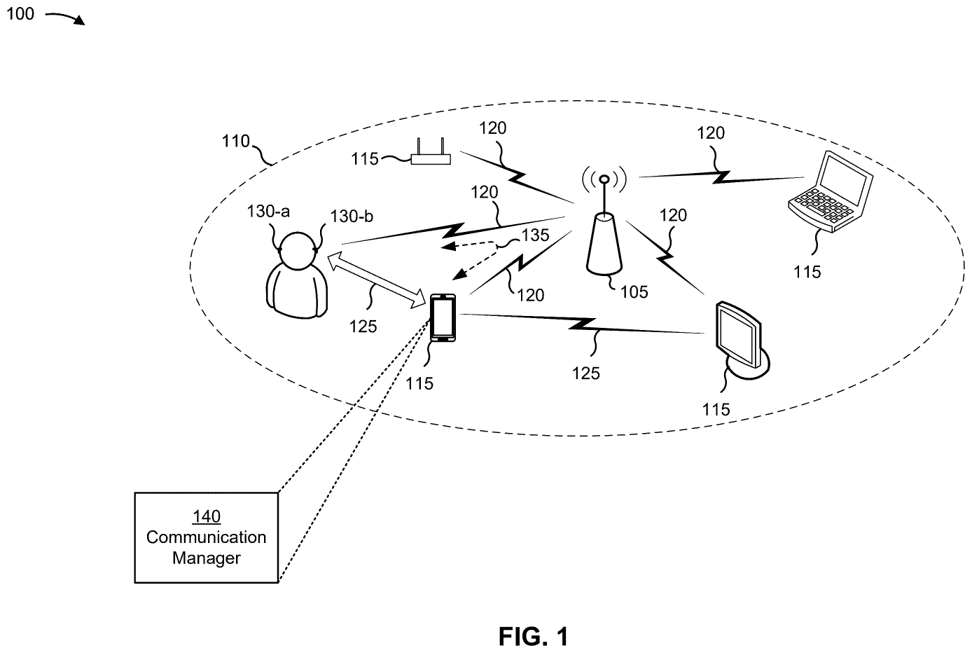

FIG. 1 shows a wireless communication network 100, in accordance with the present disclosure. The wireless communication network 100 may be a wireless local area network (WLAN) or a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include an AP 105 and multiple associated devices 115 (such as stations (STAs) or SAPs). The devices 115 may include mobile stations, personal digital assistants (PDAs), other handheld devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors, or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and/or vehicles, among other examples.

The AP 105 and the associated devices 115 (for example, associated STAs) may represent a basic service set (BSS) or an extended service set (ESS). A BSS includes devices that communicate with each other, and an ESS may include multiple BSSs or one or more BSSs and associated wired networks. The various devices 115 in the network are able to communicate with one another through the AP 105. The AP 105 may support a coverage area 110, which may represent a basic service area (BSA) of the wireless communication network 100. An extended network station (not shown) associated with the wireless communication network 100 may be connected to a wired or wireless distribution system that may allow multiple APs 105 to be connected in an ESS.

While only one AP 105 is shown in FIG. 1, the wireless communication network 100 can include multiple APs 105. The AP 105 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a RAN, including Open-RAN (O-RAN) network entities, such as a central unit (CU), a distributed unit (DU) or a radio unit (RU).

Although not shown in FIG. 1, a device 115 may be located in the intersection of more than one coverage area 110 and may associate with more than one AP 105. A single AP 105 and an associated set of devices 115 may be referred to as a BSS. A distribution system (not shown) may be used to connect APs 105 in an ESS. In some cases, the coverage area 110 of an AP 105 may be divided into sectors (also not shown). The wireless communication network 100 may include APs 105 of different types (for example, a metropolitan area, or a home network) with varying and/or overlapping coverage areas 110. Two devices 115 may also communicate directly via a direct wireless communication link 125 regardless of whether both devices 115 are in the same coverage area 110. Examples of direct wireless communication links 120 may include Wi-Fi Direct connections, Wi-Fi Tunneled Direct Link Setup (TDLS) links, and other group connections. Devices 115 and APs 105 may communicate according to the WLAN radio and baseband protocol for physical and medium access control (MAC) layers from IEEE 802.11 and versions including 802.11b, 802.11g, 802.11a, 802.11n, 802.11ac, 802.11ad, 802.11ah, and/or 802.11ax, among other examples. In other implementations, peer-to-peer connections or ad hoc networks may be implemented within wireless communication network 100.

In some cases, a device 115 (or an AP 105) may be detectable by a central AP 105, but not by other devices 115 in the coverage area 110 of the central AP 105. For example, one device 115 may be at one end of the coverage area 110 of the central AP 105 while another device 115 may be at the other end. Thus, both devices 115 may communicate with the AP 105, but may not receive the transmissions of the other. This may result in colliding transmissions for the two devices 115 in a contention-based environment (for example, carrier sense multiple access with collision avoidance (CSMA/CA)) because the devices 115 may not refrain from transmitting on top of each other. A device 115 whose transmissions are not identifiable, but that is within the same coverage area 110 may be known as a hidden node. CSMA/CA may be supplemented by the exchange of a request-to-send (RTS) packet transmitted by a sending device 115 (or AP 105) and a clear-to-send (CTS) packet transmitted by the receiving device 115 (or AP 105). This may alert other devices within range of the sender and receiver not to transmit for the duration of the primary transmission. Thus, RTS and/or CTS may help mitigate a hidden node problem.

The wireless communication network 100 may include an AP 105, devices 115 (for example, which may be referred to as source devices or central devices), and paired devices 115 (for example, which may be referred to as sink devices or peripheral devices) implementing WLAN communications (for example, Wi-Fi communications) and/or Bluetooth communications. For example, devices 115 may include cell phones, UEs, STAs, mobile stations, PDAs, other handheld devices, netbooks, notebook computers, tablet computers, laptops, or some other suitable devices. Paired devices 115 may include Bluetooth-enabled devices capable of pairing with other Bluetooth-enabled devices (for example, such as devices 115), which may include wireless audio devices (for example, headsets, earbuds, speakers, earpieces, headphones), display devices (for example, televisions or computer monitors), microphones, meters, and/or valves, among other examples. As one example, the paired devices 115 may include a wireless audio device 130-a and a wireless audio device 130-b as shown by FIG. 1 (for example, wireless earbuds), and the paired devices 115 may alternatively or additionally communicate with the AP 105. In some aspects, a paired device 115 may communicate with a device 115 using the AP 105.

“Bluetooth communications” may refer to a short-range communication protocol and may be used to connect and exchange information between devices 115 and paired devices 115 (for example, between mobile phones, computers, digital cameras, wireless headsets, speakers, keyboards, mice or other input peripherals, and similar devices). Bluetooth systems (for example, aspects of wireless communication network 100) may be organized using a central-peripheral relationship employing a time-division duplex protocol having, for example, defined time slots of 625 microseconds, in which transmission alternates between the central device (for example, a device 115) and one or more peripheral devices (for example, paired devices 115). In some examples, “device” 115 may generally refer to a central device, and “paired device” 115 may refer to a peripheral device in the wireless communication network 100. Therefore, in some examples, a device may be referred to as either a device 115 or a paired device 115 based on the Bluetooth role configuration of the device. That is, designation of a device as either a device 115 or a paired device 115 may not necessarily indicate a distinction in device capability, but rather may refer to or indicate roles held by the device in the wireless communication network 100. Generally, “device” 115 may refer to a wireless communication device capable of wirelessly exchanging data signals with another device (for example, a paired device 115), and “paired device” 115 may refer to a device operating in a peripheral role, or to a short-range wireless communication device capable of exchanging data signals with the device 115 (for example, using Bluetooth communication protocols).

A communication link 125 may be established between two Bluetooth-enabled devices (for example, between a device 115 and a paired device 115) and may provide for communications or services (for example, according to some Bluetooth profiles). The controller stack may be responsible for setting up communication links 125, such as asynchronous connection-oriented links (or asynchronous connection-oriented connections), synchronous connection-orientated (SCO) links (or SCO connections), extended synchronous connection-oriented (eSCO) links (or eSCO connections), and/or other logical transport channel links. For example, a Bluetooth connection may be an eSCO connection for voice calls (for example, which may allow for retransmission), and/or an asynchronous connection-less (ACL) connection for music streaming (for example, advanced audio distribution profile (A2DP)), among other examples. eSCO packets may be transmitted in predetermined time slots (for example, 6 Bluetooth slots each for eSCO). The regular interval between the eSCO packets may be specified when the Bluetooth link is established. The eSCO packets to/from a specific device (for example, paired device 115) are acknowledged and may be retransmitted if not acknowledged during a retransmission window. In addition, audio may be streamed between a device 115 and a paired device 115 using an ACL connection (for example, an A2DP profile). In some cases, the ACL connection may occupy 1, 3, or 5 Bluetooth slots for data or voice. Other Bluetooth profiles supported by Bluetooth-enabled devices may include Bluetooth Low Energy (BLE) (for example, providing considerably reduced power consumption and cost while maintaining a similar communication range), human interface device (HID) profile (for example, providing low latency links with low power requirements), etc.

A device 115 may, in some examples, be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some examples, Bluetooth and WLAN communications may share a same medium, such as the same unlicensed frequency medium. In such examples, a device 115 may support WLAN communications via AP 105 (for example, over communication links 120). The AP 105 and the associated devices 115 may represent a BSS or an ESS. The various devices 115 in the network may be able to communicate with one another through the AP 105. In some cases the AP 105 may be associated with a coverage area, which may represent a BSA.

Devices 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, and/or 802.11ax. In other examples, peer-to-peer connections or ad hoc networks may be implemented within wireless communication network 100, and devices may communicate with each other via communication links 120 (for example, Wi-Fi Direct connections, Wi-Fi TDLS links, peer-to-peer communication links, or other peer or group connections). AP 105 may be coupled to a network (such as the Internet) and may enable a device 115 to communicate via the network (or communicate with other devices 115 coupled to the AP 105). A device 115 may communicate with a network device bi-directionally. For example, in a WLAN, a device 115 may communicate with an associated AP 105 via downlink (for example, the communication link from the AP 105 to the device 115) and uplink (for example, the communication link from the device 115 to the AP 105).

In some examples, content, media, and/or audio, among other examples, exchanged between a device 115 and a paired device 115 may originate from a WLAN. In some examples, device 115 may receive audio from an AP 105 (for example, via WLAN communications), and the device 115 may then relay or pass the audio to the paired device 115 (for example, via Bluetooth communications and/or the AP 105). As one example, the device 115 may relay or pass the audio to the paired device 115 via the direct wireless communication link 125. Alternatively, or additionally, the device 115 may relay and/or pass the audio to the paired device via the AP 105 as shown by reference number 135. In some examples, certain types of Bluetooth communications (for example, such as high quality or high definition (HD) Bluetooth) may require enhanced quality of service. For example, in some examples, delay-sensitive Bluetooth traffic may have a higher priority than WLAN traffic.

In some examples, a wireless communication device (for example, the AP 105 and/or a device 115) may support applications associated with low-latency or lossless audio to one or more other devices, such as one or more personal audio devices. For example, a wireless communication device may support applications and use cases associated with ultra-low latency (ULL), such as ULL gaming, or streaming lossless audio to one or more personal audio devices (for example, peripheral devices) of a user or one or more headset devices (for example, AR/VR/MR/XR headset devices). In scenarios in which a user uses two or more peripheral devices (for example, a wireless audio device 130-a and a wireless audio device 130-b), the wireless communication device may support an extended personal audio network (XPAN) enabling communication with the two or more peripheral devices.

In some aspects, a wireless communication device (for example, a device 115) may include a communication manager 140. In some aspects, the wireless communication device may include a communication manager 140. As described in more detail elsewhere herein, the communication manager 140 may transmit (or cause the wireless communication device to transmit), in one or more NTN uplink transmission gap time resources, one or more WPAN communications in accordance with a first maximum transmit power; and transmit (or cause the wireless communication device to transmit), in one or more NTN uplink transmission time resources, the one or more WPAN communications in accordance with a second maximum transmit power that is greater than the first maximum transmit power. Additionally, or alternatively, the communication manager 140 may perform one or more other operations described herein.

As indicated above, FIG. 1 is provided as an example. Other examples may differ from what is described with regard to FIG. 1.

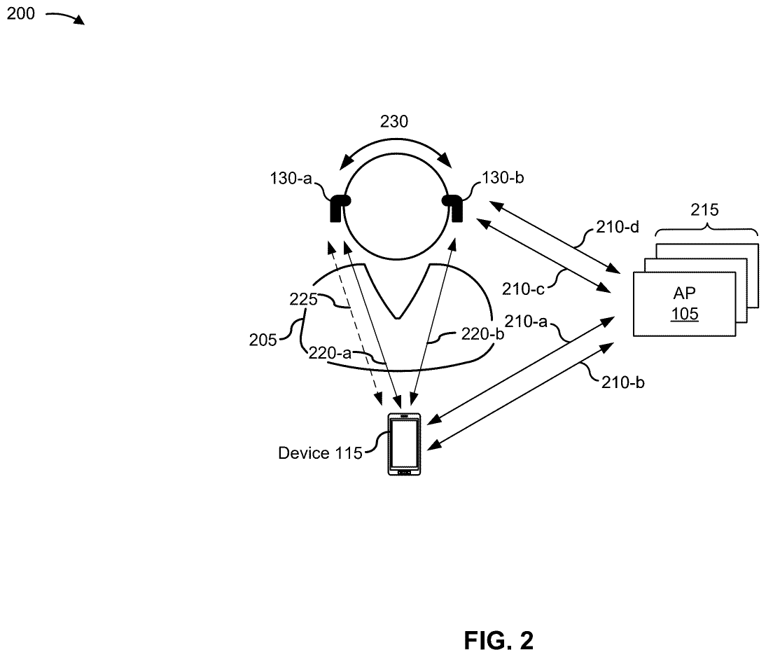

FIG. 2 illustrates an example of a wireless communication network 200 that supports XPANs in accordance with the present disclosure. The wireless communication network 200 may implement or be implemented to realize aspects of the wireless communication network 100. For example, the wireless communication network 200 illustrates communication between an AP 105, a device 115 (for example, a handset or handheld device), and a wireless audio device 130-a and a wireless audio device 130-b of a user 205 (for example, examples of audio devices and/or peripheral devices), which may be examples of corresponding devices as illustrated by and described with reference to FIG. 1. In some examples, the device 115, the wireless audio device 130-a, and the wireless audio device 130-b may support a signaling-based mechanism according to which the device 115 may transmit an indication of a set of updated parameters to each of the wireless audio device 130-a and the wireless audio device 130-b via one or audio data packets.

In some examples, the device 115 may communicate with the AP 105 via one or both of a link 210-a and a link 210-b, which may be examples of infrastructure links between the AP 105 and the device 115. Alternatively, or additionally, the AP 105 may communicate with the wireless audio device 130-a and/or the wireless audio device 130-b via one or both of a link 210-c and a link 210-d, respectively. In some examples, the wireless audio device 130-a and the wireless audio device 130-b may be connected to a same AP 105 as the device 115. In other aspects, the wireless audio device 130-a and the wireless audio device 130-b may be connected to a different AP 105 than the device 115. Accordingly, and as shown by reference number 215, the device 115, the wireless audio device 130-a, and/or the wireless audio device 130-b may communicate with one another via multiple APs 105. The link 210-a may be an example of a 2.4 GHz link between the AP 105 and the device 115, and the link 210-b may be an example of a 5 GHz link or a 6 GHz link between the AP 105 and the device 115. In some examples, the link 210-c and/or the link 210-d may be a 2.4 GHz link, a 5 GHZ, and/or a 6 GHz link.

The device 115 may communicate wirelessly with each of the wireless audio device 130-a and the wireless audio device 130-b, where each of the wireless audio device 130-a and the wireless audio device 130-b may be associated with an XPAN of the device 115. For example, the device 115 may communicate with the wireless audio device 130-a via a link 220-a and may communicate with the wireless audio device 130-b via a link 220-b, where the link 220-a and the link 220-b may be referred to or understood as XPAN links. The link 220-a may be an example of a 5 GHz link or a 6 GHz link and the link 220-b may be an example of a 5 GHz link or a 6 GHz link. Additionally, in some examples, the device 115 may communicate with the wireless audio device 130-a, which may be an example of a primary earbud, via a communication link 225. The communication link 225 may be an example of a Bluetooth link between the device 115 and the wireless audio device 130-a. The wireless audio device 130-a and the wireless audio device 130-b, which may be an example of a secondary audio device, may communicate with each other via a link 230, which may be an example of a Bluetooth link between the wireless audio device 130-a and the wireless audio device 130-b.

The device 115 may communicate with the wireless audio device 130-a and/or the wireless audio device 130-b via one or more APs 105. To illustrate, the device 115 may communicate with a first AP 105 via the link 210-a and/or the link 210-b. The first AP 105 may be connected to a second AP 105, and the second AP 105 may be connected to the wireless audio device 130-a and/or the wireless audio device 130-b via the link 210-c and/or the link 210-d. Accordingly, the device 115 may communicate with the wireless audio device 130-a and/or the wireless audio device 130-b based at least in part on communicating with the first AP 105, the first AP 105 communicating with the second AP 105, and the second AP 105 communicating with the wireless audio device 130-a and/or the wireless audio device 130-b. However, in other examples, the device 115, the wireless audio device 130-a, and/or the wireless audio device 130-b may be connected to a same AP 105.

As indicated above, FIG. 2 is provided as an example. Other examples may differ from what is described with regard to FIG. 2.

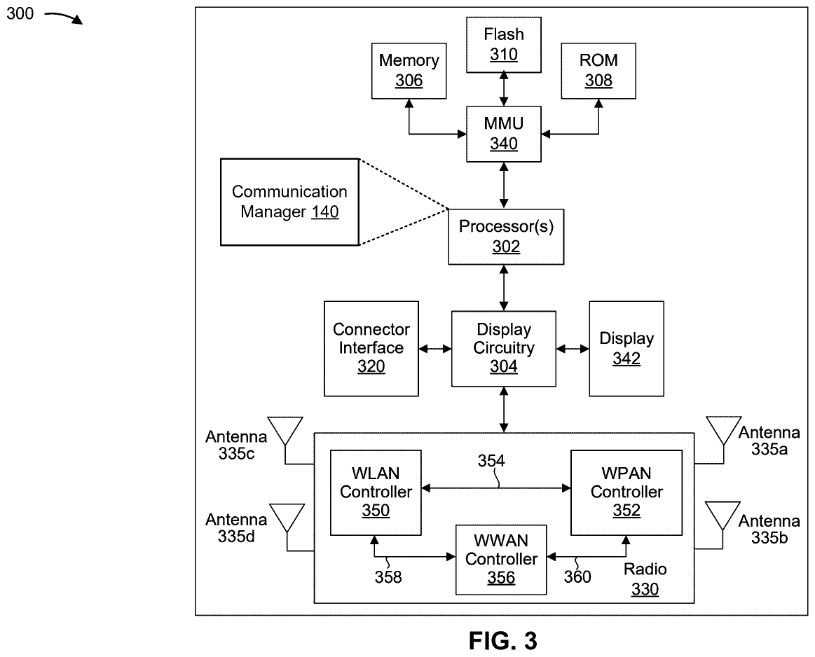

FIG. 3 is a diagram illustrating an example of a wireless communication device 300, in accordance with the present disclosure. In some aspects, the wireless communication device 300 may be an example of the AP 105, the device 115, and/or the wireless audio device 130 described above. In some examples, the AP 105, the device 115, and/or the wireless audio device 130 may include one or more wireless communication devices 300 and/or one or more components of wireless communication device 300.

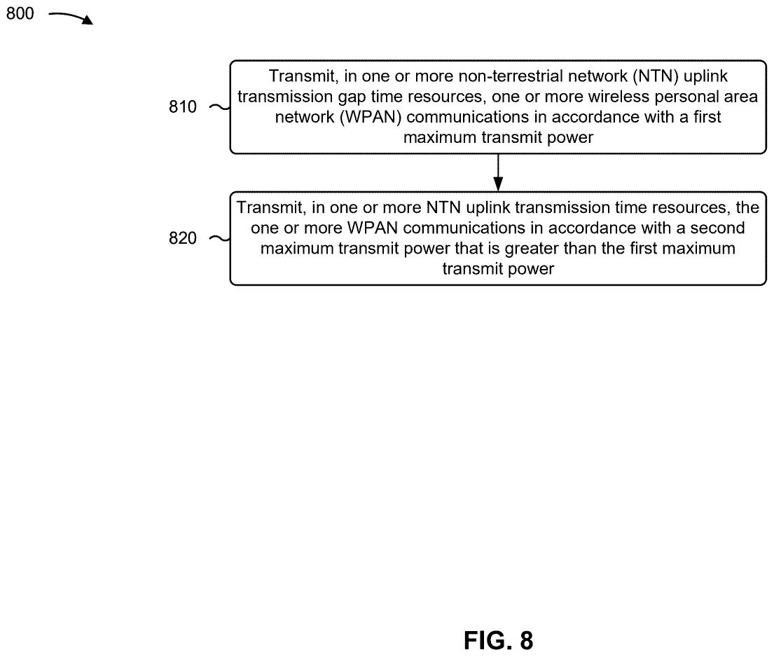

In some examples, the wireless communication device 300 is configured to perform the process 800 of FIG. 8, or other processes as described herein. The wireless communication device 300 may include one or more chips, system-on-chips (SoCs), chipsets, packages, components or devices that individually or collectively constitute or comprise a processing system. The processing system may interface with other components of the wireless communication device 300, and may generally process information (such as inputs or signals) received from such other components and output information (such as outputs or signals) to such other components. In some examples, an example chip may include a processing system, a first interface to output or transmit information and a second interface to receive or obtain information. For example, the first interface may refer to an interface between the processing system of the chip and a transmission component, such that the wireless communication device 300 may transmit the information output from the chip. In such an example, the second interface may refer to an interface between the processing system of the chip and a reception component, such that the wireless communication device 300 may receive information that is passed to the processing system. In some such examples, the first interface also may obtain information, such as from the transmission component, and the second interface also may output information, such as to the reception component.

As shown in FIG. 3, the wireless communication device 300 may include processor (or “processing”) circuitry in the form of one or multiple processors, such as processor(s) 302. The processor (or “processing”) circuitry may be in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processor(s) 302 may execute program instructions for the wireless communication device 300. One or more of the processor(s) 302 may be individually or collectively configurable or configured to perform various functions or operations described herein. A group of processor(s) 302 collectively configurable or configured to perform a set of functions may include a first processor configurable or configured to perform a first function of the set and a second processor configurable or configured to perform a second function of the set, or may include the group of processors all being configured or configurable to perform the set of functions.

The wireless communication device 300 may also include a display 342 that can perform graphics processing and present information to a user. The processor(s) 302 may also be coupled to memory management unit (MMU) 340, which may be configured to receive addresses from the processor(s) 302 and translate the addresses to address locations in memory such as memory 306, read-only memory (ROM) 308, or flash memory 310 and/or to address locations in other circuits or devices, such as the display circuitry 304, radio 330, connector interface 320, and/or display 342. The MMU 340 may also be configured to perform memory protection and page table translation or set up. In some aspects, the MMU 340 may be included as a portion of the processor(s) 302. In some aspects, the wireless communication device 300 may include a communication manager (for example, communication manager 140) that controls the wireless communication device 300 or processor(s) 302 to perform the processes described herein.

In some examples, the processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”), such as the memory 306, ROM 308, and/or flash memory 310. One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

The processor(s) 302 may be coupled to other circuits of the wireless communication device 300. For example, the wireless communication device 300 may include various memory types, a connector interface 320 through which the wireless communication device 300 can communicate with the computer system, and wireless communication subsystems that can transmit data to, and receive data from, other devices based on one or more wireless communication standards or protocols. For example, in some aspects, the wireless communication subsystems may include (but are not limited to) a WLAN subsystem, a WPAN subsystem, and/or a cellular subsystem (such as an LTE or NR subsystem). The wireless communication device 300 may include multiple antennas 335a, 335b, 335c, and/or 335d for performing wireless communication with, for example, wireless communication devices in a WPAN.

The wireless communication device 300 may be configured to implement part or all of the techniques described herein by executing program instructions stored on a memory medium (such as a non-transitory computer-readable memory medium) and/or through hardware or firmware operation. In other embodiments, the techniques described herein may be at least partially implemented by a programmable hardware element, such as a field-programmable gate array (FPGA), and/or an application specific integrated circuit (ASIC).

In certain aspects, the radio 330 may include separate controllers configured to control communications for various respective radio access technology (RAT) protocols. For example, as shown in FIG. 3, radio 330 may include a WLAN controller 350 that manages WLAN communications, a WPAN controller 352 that manages Bluetooth, BLE, and/or other suitable WPAN communications, and a WWAN controller 356 that manages WWAN communications. In some aspects, the wireless communication device 300 may store and execute a WLAN software driver for controlling WLAN operations performed by the WLAN controller 350, a WPAN software driver for controlling WPAN operations performed by the WPAN controller 352, and/or a WWAN software driver for controlling WWAN operations performed by the WWAN controller 356.

In some aspects, a first coexistence interface 354 (such as a wired interface) may be used for sending information between the WLAN controller 350 and the WPAN controller 352. Additionally, or alternatively, in some aspects, a second coexistence interface 358 may be used for sending information between the WLAN controller 350 and the WWAN controller 356. Additionally, or alternatively, in some aspects, a third coexistence interface 360 may be used for sending information between the WPAN controller 352 and the WWAN controller 356. In some examples, one or more of the WLAN controller 350, the WPAN controller 352, and/or the WWAN controller 356 may be implemented as hardware, software, firmware or some combination thereof.

In some aspects, the WLAN controller 350 may be configured to communicate with a second device in a WPAN using a WLAN link using one or more, some, or all of the antennas 335a, 335b, 335c, and 335d. In other configurations, the WPAN controller 352 may be configured to communicate with at least one second device in a WPAN using one or more, some, or all of the antennas 335a, 335b, 335c, and 335d. In other configurations, the WWAN controller 356 may be configured to communicate with a second device in a WPAN using one or more, some, or all of the antennas 335a, 335b, 335c, and 335d. The WLAN controller 350, the WPAN controller 352, and/or the WWAN controller 356 may be configured to adjust a wakeup time interval and a shutdown time for the wireless communication device 300.

A short-range wireless communications protocol, such as Bluetooth (BT), BLE, and/or basic rate (BR)/enhanced data rate (EDR), may include and/or may use one or more other communications protocols, for example, to establish and maintain communications links. In some examples, the wireless communication device 300 may establish a communications link with one or more peripheral devices, such as a wireless headset or wireless earbuds, according to at least one communications protocol for short-range wireless communications. In some aspects, the communications link may include a communications link that adheres to a protocol included and/or for use with BT, BLE, and/or BR/EDR, among other examples. In one aspect, the communications link may include an asynchronous connection-oriented logical transport, sometimes referred to as an ACL link. When operating as an ACL link, the communications link may allow the wireless communication device 300 to connect or “pair” with a peripheral device. The connection is asynchronous in that the two devices may not need to synchronize, timewise, data communications between each other to permit communication of data packets via the communications link.

In some examples, a logical link control and adaptation protocol (L2CAP) may be used within a BT protocol stack (not shown in FIG. 3). An L2CAP connection may be established after an ACL link has been established. Reference to L2CAP in the present disclosure may be further applicable to enhanced L2CAP (EL2CAP), which may be an enhanced version of the L2CAP protocol that enables multiplexing of multiple logical data channels via a single radio connection.

In some examples, the communications link may include an A2DP link. For example, an A2DP link may provide a point-to-point link between a source device, such as the wireless communication device 300, and a sink device, such as the wireless earbuds 130-a and 130-b. With an A2DP link, data packets including audio may be transmitted over an ACL channel, and other information (for example, for controlling the audio stream) may be transmitted over a separate control channel. The data packets may occur non-periodically.

In some examples, the communications link may support synchronous logical transport mechanisms between a source device and a peripheral device. For example, the communications link 116 may include an SCO link that provides a symmetric point-to-point link between the source device and the peripheral device using time slots reserved for BT communications. In some aspects, an SCO link may not support retransmission of data packets, which may be unsatisfactory in audio streaming and/or voice call use cases in which a dropped audio or voice packet may reduce the quality of the user experience. Accordingly, in some aspects, the communications link may include an eSCO link. An eSCO link may provide a symmetric or asymmetric point-to-point link between a source device and a peripheral device using time slots reserved for BT communications, and may also provide for a retransmission window following the reserved time slots. Because retransmissions may be facilitated using the retransmission window, an eSCO link may be suitable for audio streaming and/or voice call use cases because a dropped audio or voice packet may be retransmitted, and therefore the probability of successfully receiving a data packet may be increased.

In some aspects, the communications link may include an isochronous (ISO) link. When operating as an ISO link, the communications link 116 may combine some features of both synchronous and asynchronous links. For example, a stream on an ISO link may begin with a start packet, and then data packets may be asynchronously transmitted. On an ISO link, the number of retransmission attempts by a transmitting device may be limited. Thus, if a receiving device is unable to decode a data packet within the limited number of retransmission attempts, then the data packet may be dropped, and the receiving device may continue to receive the stream without data from the dropped data packet.

In some aspects, the wireless communication device 300 may include means for transmitting, in one or more NTN uplink transmission gap time resources, one or more WPAN communications in accordance with a first maximum transmit power and/or means for transmitting, in one or more NTN uplink transmission time resources, the one or more WPAN communications in accordance with a second maximum transmit power that is greater than the first maximum transmit power. In some aspects, the means for the wireless communication device 300 to perform operations described herein may include, for example, one or more of antennas 335a-335d, WPAN controller 352, WLAN controller 350, radio 330, and/or processor 302, among other examples.

The number and arrangement of components shown in FIG. 3 are provided as an example. In practice, wireless communication device 300 may include additional components, fewer components, different components, or differently arranged components than those shown in FIG. 3. Additionally, or alternatively, a set of components (for example, one or more components) of wireless communication device 300 may perform one or more functions described as being performed by another set of components of wireless communication device 300.

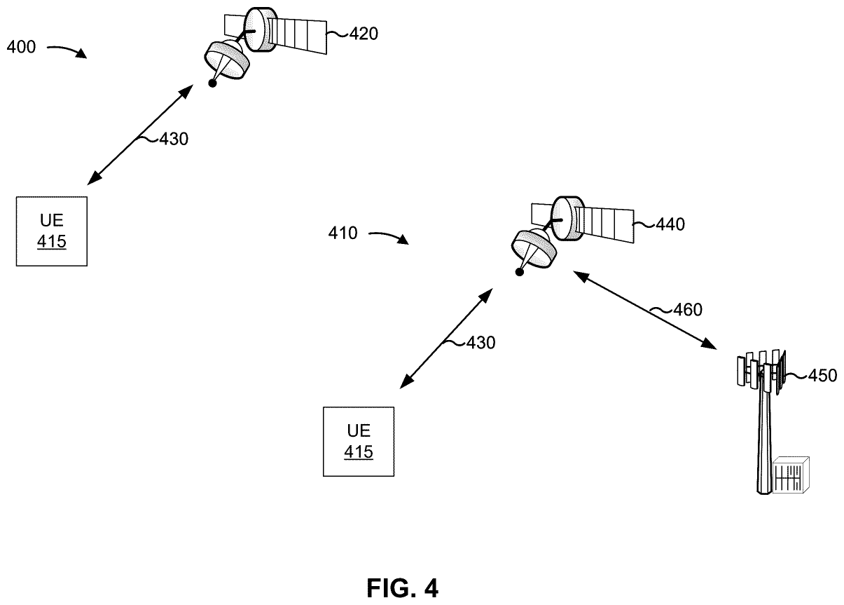

FIG. 4 is a diagram illustrating an example 400 of a regenerative satellite deployment and an example 410 of a transparent satellite deployment in an NTN.

Example 400 shows a regenerative satellite deployment. In example 400, a UE 415 (e.g., a device 115) is served by a satellite 420 via a service link 430. For example, the satellite 420 may include a network node (e.g., a gNB). In some aspects, the satellite 420 may be referred to as a non-terrestrial base station, a regenerative repeater, or an on-board processing repeater. In some aspects, the satellite 420 may demodulate an uplink radio frequency signal, and may modulate a baseband signal derived from the uplink radio signal to produce a downlink radio frequency transmission. The satellite 420 may transmit the downlink radio frequency signal on the service link 430. The satellite 420 may provide a cell that covers the UE 415.

Example 410 shows a transparent satellite deployment, which may also be referred to as a bent-pipe satellite deployment. In example 410, a UE 415 is served by a satellite 440 via the service link 430. The satellite 440 may be a transparent satellite. The satellite 440 may relay a signal received from gateway 450 via a feeder link 460. For example, the satellite may receive an uplink radio frequency transmission, and may transmit a downlink radio frequency transmission without demodulating the uplink radio frequency transmission. In some aspects, the satellite may convert the uplink radio frequency transmission received on the service link 430 to a frequency of the uplink radio frequency transmission on the feeder link 460, and may amplify and/or filter the uplink radio frequency transmission. In some aspects, the UEs 415 shown in example 400 and example 410 may be associated with a Global Navigation Satellite System (GNSS) capability or a Global Positioning System (GPS) capability, though not all UEs have such capabilities. The satellite 440 may provide a cell that covers the UE 415.

The service link 430 may include a link between the satellite 440 and the UE 415, and may include one or more of an uplink or a downlink. The feeder link 460 may include a link between the satellite 440 and the gateway 450, and may include one or more of an uplink (e.g., from the UE 415 to the gateway 450) or a downlink (e.g., from the gateway 450 to the UE 415). An uplink of the service link 430 may be indicated by reference number 430-U (not shown in FIG. 4) and a downlink of the service link 430 may be indicated by reference number 430-D (not shown in FIG. 4). Similarly, an uplink of the feeder link 460 may be indicated by reference number 460-U (not shown in FIG. 4) and a downlink of the feeder link 460 may be indicated by reference number 460-D (not shown in FIG. 4).

The feeder link 460 and the service link 430 may each experience Doppler effects due to the movement of the satellites 420 and 440, and potentially movement of a UE 415. These Doppler effects may be significantly larger than in a terrestrial network. The Doppler effect on the feeder link 460 may be compensated for to some degree, but may still be associated with some amount of uncompensated frequency error. Furthermore, the gateway 450 may be associated with a residual frequency error, and/or the satellite 420/440 may be associated with an on-board frequency error. These sources of frequency error may cause a received downlink frequency at the UE 415 to drift from a target downlink frequency.

In some examples, the NTN shown in FIG. 4 may be a NB-NTN. The UE 415 may transmit one or more NB-NTN uplink data communications during a plurality of NPUSCH time windows. For example, an NPUSCH time window may have a duration of 256 ms. The NPUSCH time windows may be separated by a gap (e.g., an NB-NTN gap) during which the UE 415 may monitor for one or more NSSSs. For example, a gap may have a duration of 40 ms, and an NSSS may be transmitted every 20 ms. The UE 415 may use the NSSS for downlink frequency estimation. The NB-NTN may alternate between the NPUSCH time windows (for uplink transmissions) and the gaps (for downlink transmissions) because the NB-NTN is a half-duplex system, meaning that a NB-NTN cannot support transmission of an uplink communication and a downlink communication simultaneously.

The NB-NTN may operate in one or more NB-NTN frequency bands shown in Table 1 below. The NB-NTN frequency bands may be close to and/or overlap with a Bluetooth (e.g., BLE) 2.4 GHz frequency band. For example, NB-NTN band B256 may use 2170-2200 MHz for downlink NB-NTN communications. As a result, Bluetooth communications may act as an aggressor and/or jammer to NB-NTN communications. In some examples, amplitude modulation (AM) of Bluetooth jamming signals may become significant at the downconverter at a mixer baseband output. Thus, for example, high Bluetooth transmit power during a gap may corrupt the NSSS, which may result in uplink frequency error due to local oscillator drift. Additionally, or alternatively, the high Bluetooth transmit power may corrupt one or more other NB-NTN downlink communications.

TABLE 1

| NB-NTN Band | Uplink | Downlink |
|---|---|---|
| B255 | 1626.5 MHz-1660.5 MHz | 1525 MHz-1559 MHz |
| B256 | 1980-2010 MHz | 2170 MHz-2200 MHz |
| B23 | 2000-2020 MHz | 2180 MHz-2200 MHz |
| B253 | 1668 MHz-1675 MHz | 1518 MHz-1525 MHz |

Therefore, the UE 415 may reduce Bluetooth transmit power (“transmit power backoff” or “backoff”), which may mitigate desensing of the NB-NTN. For example, the UE 415 may reduce the Bluetooth transmit power to a constant power level across NPUSCH time windows and gaps. For example, when NB-NTN is awake in CDRX or awake in IDRX, the UE 415 may instigate a transmit power backoff to a power level x (PLx), where PLx is lower than a maximum power level. However, the backoff may prevent successful communication over a Bluetooth link. For example, a user that is wearing a Bluetooth device may be in an accident that results in the UE 415 being far away from the user; in such cases, the UE 415 may be in a far cell condition such that the reduced transmit power is insufficient to enable the user to use a voice command to prompt the UE 415 to send an emergency text message.

As indicated above, FIG. 4 is provided as an example. Other examples may differ from what is described with regard to FIG. 4.

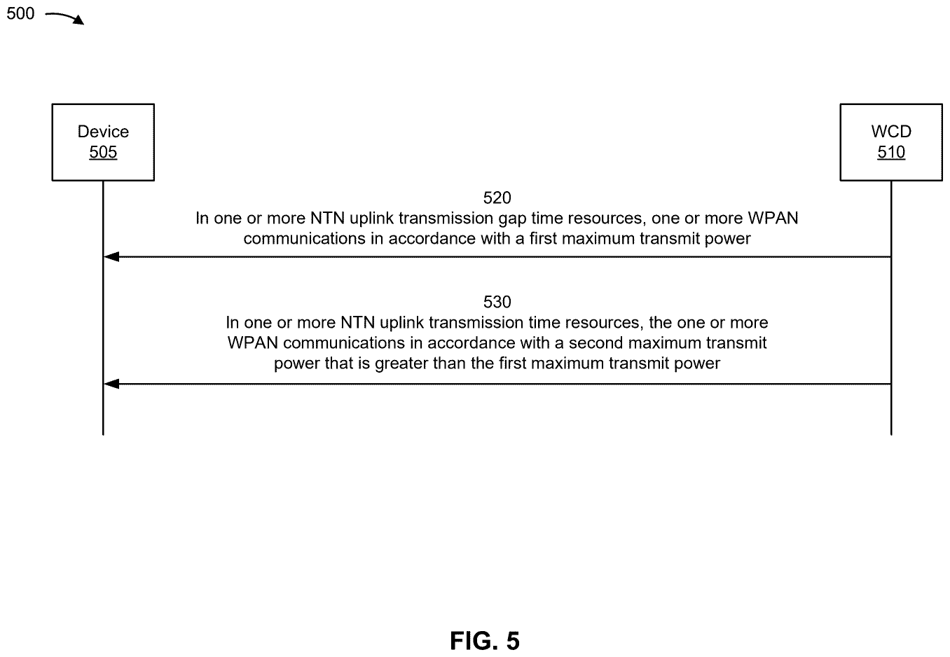

FIG. 5 is a diagram illustrating an example 500 associated with signaling to support WPAN and NTN coexistence, in accordance with the present disclosure. As shown in FIG. 5, a device 505 and a wireless communication device (“WCD”) 510 may communicate with one another. For example, the device 505 may be a wireless audio device 130 (e.g., a Bluetooth-capable wireless audio device), and the wireless communication device 510 (e.g., the device 115, the wireless communication device 300, the UE 415, or the like) may be a NB-NTN-capable device.

In some aspects, the wireless communication device 510 may receive an uplink grant that indicates one or more NTN uplink transmission gap time resources and one or more NTN uplink transmission time resources. The one or more NTN uplink transmission gap time resources may be time resources (e.g., slots) in which NTN uplink transmissions (e.g., NPUSCH transmissions) are postponed. The one or more NTN uplink transmission time resources may be time resources (e.g., slots) in which NTN uplink transmissions (e.g., NPUSCH transmissions) can be scheduled. For example, the one or more NTN uplink transmission gap time resources may be one or more NB-NTN uplink transmission gap time resources (e.g., the gaps discussed above in connection with FIG. 4), and the one or more NTN uplink transmission time resources may be one or more NB-NTN uplink transmission time resources (e.g., the NPUSCH time windows discussed above in connection with FIG. 4). The wireless communication device 510 may identify, based at least in part on information provided by or derived from the uplink grant, the one or more NTN uplink transmission gap time resources and the one or more NTN uplink transmission time resources. For example, the information provided by or derived from the uplink grant may include a quantity of NPUSCH transmissions that satisfies the uplink grant, a start time of an NPUSCH transmission scheduled by the uplink grant, an end time of an NPUSCH transmission scheduled by the uplink grant, a start time of the one or more NTN uplink transmission gap time resources, an end time of the one or more NTN uplink transmission gap time resources, or the like. In some examples, an NTN entity of the wireless communication device 510 may identify the one or more NTN uplink transmission gap time resources and the one or more NTN uplink transmission time resources. The NTN entity may be an NTN controller (e.g., an NB-NTN controller) of the wireless communication device 510, an NTN module (e.g., an NB-NTN module) of the wireless communication device 510, NTN firmware (e.g., NB-NTN firmware) of the wireless communication device 510, or the like.

In some aspects, the NTN entity may indicate, to a controller of the wireless communication device 510, the one or more NTN uplink transmission gap time resources and the one or more NTN uplink transmission time resources. For example, the NTN entity may share, with the controller, a duration of one or more NPUSCH transmissions scheduled by the uplink grant. The controller may be responsible for handling coexistence between the WPAN and the NTN. The controller may be referred to as a “coexistence controller.”

As shown by reference number 520, the wireless communication device 510 may transmit, and the device 505 may receive, in the one or more NTN uplink transmission gap time resources, one or more WPAN communications in accordance with a first maximum transmit power. For example, the wireless communication device 510 may apply a transmit power backoff by transmitting the one or more WPAN communications during the one or more gaps at a transmit power that is less than or equal to the first maximum transmit power. For example, a WPAN entity of the wireless communication device 510 may apply the transmit power backoff. The WPAN entity may be a WPAN controller (e.g., a Bluetooth controller) of the wireless communication device 510, a WPAN module (e.g., a Bluetooth module) of the wireless communication device 510, WPAN firmware (e.g., Bluetooth firmware) of the wireless communication device 510, or the like. The transmit power of the one or more WPAN communications during the one or more gaps may depend on a battery level of the wireless communication device 510. In some examples, the one or more WPAN communications may be Bluetooth communications.

As shown by reference number 530, the wireless communication device 510 may transmit, and the device 505 may receive, in one or more NTN uplink transmission time resources, the one or more WPAN communications in accordance with a second maximum transmit power that is greater than the first maximum transmit power. For example, the wireless communication device 510 may transmit the one or more WPAN communications during the one or more NPUSCH time windows at a transmit power that is less than or equal to the second maximum transmit power. For example, the transmit power of the one or more WPAN communications during the one or more NPUSCH time windows may depend on a battery level of the wireless communication device 510. Because the second maximum transmit power is greater than the first maximum transmit power, the wireless communication device 510 may transmit the one or more WPAN communications during the one or more NTN uplink transmission time resources at a greater transmit power than the transmit power of the one or more WPAN communications transmitted during the one or more NTN uplink transmission gap time resources.

In some aspects, the wireless communication device 510 may transmit, and the device 505 may receive, the one or more WPAN communications in the one or more NTN uplink transmission time resources based at least in part on a time duration of the one or more NTN uplink transmission time resources satisfying a time duration threshold. For example, the wireless communication device 510 may transmit the one or more WPAN communications in the one or more NTN uplink transmission time resources at a transmit power up to the second maximum transmit power if the time duration of the NTN uplink transmission time resource(s) is greater than the time duration threshold (e.g., a predefined time duration threshold). For example, the uplink grant may schedule a series of NPUSCH time windows, each 256 ms except for a final NPUSCH time window, which may carry any remaining NPUSCH data and be less than 256 ms; in this example, all NPUSCH time windows in the series except for the final NPUSCH time window may carry the one or more WPAN communications transmitted in accordance with the second maximum transmit power.

In some aspects, the controller of the wireless communication device 510 may indicate, to the WPAN entity of the wireless communication device 510, a switch to the second maximum transmit power. For example, the controller of the wireless communication device 510 may determine, by comparing the time duration of the one or more NTN uplink transmission time resources to the time duration threshold, that the one or more WPAN communications to be transmitted in the one or more NTN uplink transmission time resources are permitted to be transmitted with a transmit power in accordance with the second maximum transmit power. The controller may then notify the WPAN entity that a current maximum transmit power is to change to the second maximum transmit power (if the current maximum transmit power is different than the second maximum transmit power).

In some aspects, the wireless communication device 510 may transmit, in one or more NTN downlink transmission time resources, the one or more WPAN communications in accordance with a third maximum transmit power that is less than the second maximum transmit power. The one or more NTN downlink transmission time resources may be time resources (e.g., slots) in which NTN downlink transmissions can be scheduled in an NB-NTN downlink channel. In some examples, the wireless communication device 510 may apply a transmit power backoff by transmitting the one or more WPAN communications during the one or more NTN downlink transmission time resources at a transmit power that is less than or equal to the third maximum transmit power. For example, the transmit power of the one or more WPAN communications during the one or more NTN downlink transmission time resources may depend on a battery level of the wireless communication device 510. Because the third maximum transmit power is less than the second maximum transmit power, the wireless communication device 510 may transmit the one or more WPAN communications during the one or more NTN uplink transmission time resources at a greater transmit power than the transmit power of the one or more WPAN communications transmitted during the one or more NTN downlink transmission time resources.

In some aspects, the first maximum transmit power may be less than the third maximum transmit power. For example, the wireless communication device 510 may transmit the one or more WPAN communications during the one or more NTN uplink transmission gap time resources at a lower transmit power than the transmit power of the one or more WPAN communications transmitted during the one or more NTN downlink transmission gap time resources.

In some aspects, the first maximum transmit power may be equal to the third maximum transmit power. For example, the wireless communication device 510 may transmit the one or more WPAN communications during the one or more NTN uplink transmission gap time resources and the one or more WPAN communications during the one or more NTN uplink transmission gap time resources in accordance with the same maximum transmit power.

In some aspects, the first maximum transmit power may be greater than the third maximum transmit power. For example, the wireless communication device 510 may transmit the one or more WPAN communications during the one or more NTN uplink transmission gap time resources at a greater transmit power than the transmit power of the one or more WPAN communications transmitted during the one or more NTN downlink transmission gap time resources.

In some aspects, the wireless communication device 510 may transmit the one or more WPAN communications in the one or more NTN uplink transmission time resources at a transmit power associated with an NTN sleep time window of a CDRX or IDRX cycle that is greater than a transmit power associated with an NTN awake time window of the CDRX or IDRX cycle. A transmit power may be associated with the NTN sleep time window in that the wireless communication device 510 may use that transmit power during the NTN sleep time window. A transmit power may be associated with the NTN awake time window in that the wireless communication device 510 may use that transmit power during the NTN awake time window. During the NTN sleep time window, the wireless communication device 510 may have an NTN sleep status or state. During the NTN awake time window, the wireless communication device 510 may have an NTN awake status or state. In some examples, the NTN entity may indicate, to the controller, that the wireless communication device 510 is in the NTN sleep status or state or the NTN awake status or state.

As indicated above, FIG. 5 is provided as an example. Other examples may differ from what is described with respect to FIG. 5.

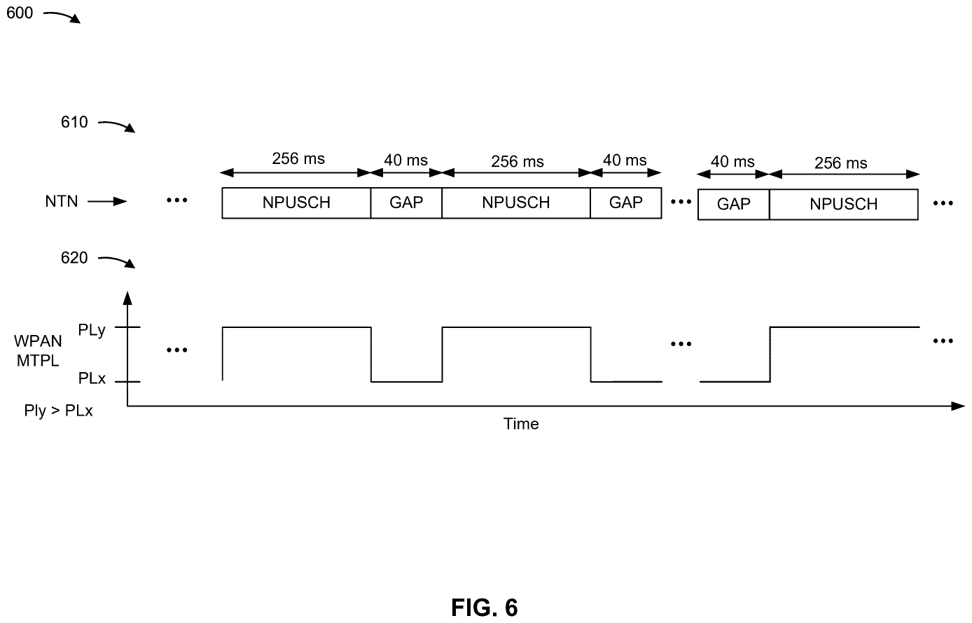

FIG. 6 is a diagram illustrating an example 600 associated with a maximum transmit power limit (MTPL) for Bluetooth 2.4 GHz communications during an NB-NTN NPUSCH-gap cycle, in accordance with the present disclosure.

As shown by reference number 610, the NB-NTN NPUSCH-gap cycle may include a series of alternating 256 ms NPUSCH time windows and 40 ms gaps. As shown by reference number 620, a first maximum transmit power for WPAN communications that applies during the gaps may be greater than a second maximum transmit power for WPAN communications that applies during the NPUSCH time windows. For example, the first maximum transmit power may be PLx, and the second maximum transmit power may be power level y (PLy), where PLy may be greater than PLx.

As indicated above, FIG. 6 is provided as an example. Other examples may differ from what is described with respect to FIG. 6.

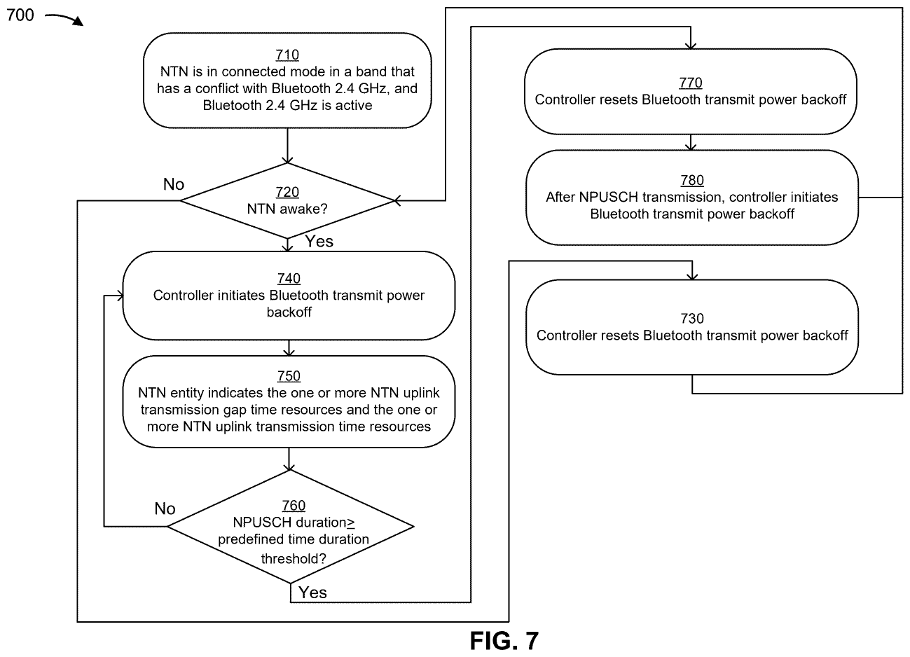

FIG. 7 is a diagram illustrating an example 700 associated with a flowchart for WPAN and NTN coexistence, in accordance with the present disclosure.

As shown by reference number 710, NB-NTN may be in a connected mode and operating in a band conflicts with Bluetooth (e.g., BLE) 2.4 GHZ, and Bluetooth 2.4 GHz may be active. As shown by reference number 720, the controller of the wireless communication device 510 may determine an NB-NTN awake status. If the NB-NTN is not awake, then, as shown by reference number 730, the controller may reset a Bluetooth transmit power backoff. For example, the controller of the wireless communication device 510 may send, to the WPAN entity, an indication to reset the Bluetooth transmit power backoff, which may enable the wireless communication device 510 to transmit one or more Bluetooth communications up to a maximum transmit power of the wireless communication device 510. The controller may continue to check the NB-NTN awake status, as shown by reference number 720. If the NB-NTN is awake, then, as shown by reference number 740, the controller may initiate Bluetooth transmit power backoff, which may protect NB-NTN communications. For example, the controller of the wireless communication device 510 may send, to the WPAN entity of the wireless communication device 510, an indication to perform the Bluetooth transmit power backoff, which may enable the wireless communication device 510 to transmit one or more Bluetooth communications up to the first maximum transmit power.

In some aspects, the wireless communication device 510 may receive an uplink grant that indicates the one or more NTN uplink transmission gap time resources and the one or more NTN uplink transmission time resources. For example, the wireless communication device 510 may identify, based at least in part on information provided by or derived from the uplink grant, the one or more NTN uplink transmission gap time resources and the one or more NTN uplink transmission time resources, as discussed above in connection with FIG. 5.

As shown by reference number 750, the NTN entity may indicate, based at least in part on the uplink grant, to the controller, the one or more NTN uplink transmission gap time resources and the one or more NTN uplink transmission time resources. For example, the NTN entity may share, with the controller, a duration of one or more NPUSCH transmissions scheduled by the uplink grant, a start time of the one or more NPUSCH transmissions, a start time of one or more gaps, or the like. In some examples, the NTN entity may indicate the one or more NTN uplink transmission gap time resources and the one or more NTN uplink transmission time resources before transmitting any NPUSCH communications in the NB-NTN connected mode.

In some aspects, the controller may indicate, to the WPAN entity, based at least in part on a time duration of the one or more NTN uplink transmission time resources satisfying a time duration threshold, a switch to the second maximum transmit power. For example, as discussed above in connection with FIG. 5, and as shown by reference number 760, the controller may determine whether the time duration (e.g., an NPUSCH duration) is greater than or equal to the time duration threshold (e.g., a predefined time duration threshold). If the time duration is less than the time duration threshold, then the controller may initiate the Bluetooth transmission power backoff as shown by reference number 740.

If the time duration is greater than or equal to the time duration threshold, then, as shown by reference number 770, the controller may reset the Bluetooth transmit power. As shown by reference number 780, the controller may initiate the Bluetooth transmit power backoff. In some examples, the controller may initiate the Bluetooth transmit power backoff responsive to (e.g., immediately after) an end of the NPUSCH transmission. The controller may continue to determine the NB-NTN awake status, as shown by reference number 720.

As indicated above, FIG. 7 is provided as an example. Other examples may differ from what is described with respect to FIG. 7.

Transmitting the one or more WPAN communications in the one or more NTN uplink transmission time resources in accordance with the second maximum transmit power that is greater than the first maximum transmit power may help to improve a coexistence of NB-NTN and WPAN (e.g., Bluetooth). For example, the first maximum transmit power may help to protect NB-NTN communications, such as the NSSS, and the second maximum transmit power (e.g., involving little or no Bluetooth transmit power backoff) may enable a larger WPAN communication range and/or maximum allowable path loss (MAPL) between the wireless communication device 510 and the device 505. For example, if a user is wearing the device 505 and is involved in an accident that results in wireless communication device 510 being far away from the user, then the WPAN entity may be in a far cell condition, and the second maximum transmit power may enable the user to use a voice command to prompt the wireless communication device 510 to send an emergency text message.

Transmitting the one or more WPAN communications based at least in part on the time duration of the one or more NTN uplink transmission time resources satisfying the time duration threshold may help to ensure that the WPAN entity has sufficient time to receive an indication of, and apply, a transmit power backoff reset. For example, if a final NPUSCH time window is less than the time duration threshold, then the wireless communication device 510 may be unable to switch between maximum power thresholds for the final NPUSCH time window.

Transmitting the one or more WPAN communications in the one or more NTN downlink transmission time resources in accordance with the third maximum transmit power may help to protect NB-NTN downlink communications by mitigating jamming effects on the NB-NTN downlink communications caused by the one or more WPAN communications.

FIG. 8 is a diagram illustrating an example process 800 performed, for example, at a wireless communication device or an apparatus of a wireless communication device, in accordance with the present disclosure. Example process 800 is an example where the apparatus or the wireless communication device (e.g., wireless communication device 510) performs operations associated with maximum transmit power for WPAN communications in NTN time resources.

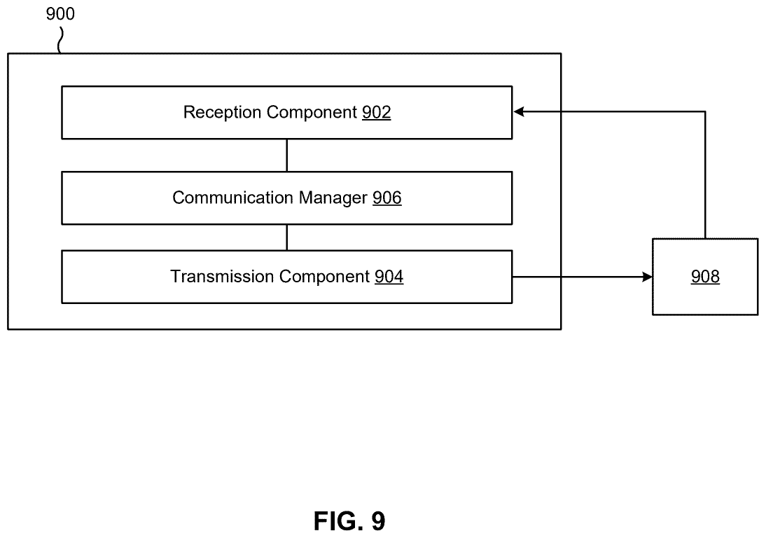

As shown in FIG. 8, in some aspects, process 800 may include transmitting, in one or more NTN uplink transmission gap time resources, one or more WPAN communications in accordance with a first maximum transmit power (block 810). For example, the wireless communication device (e.g., using reception component 902 and/or communication manager 906, depicted in FIG. 9) may receive, in one or more NTN uplink transmission gap time resources, one or more WPAN communications in accordance with a first maximum transmit power, as described above.

As further shown in FIG. 8, in some aspects, process 800 may include transmitting, in one or more NTN uplink transmission time resources, the one or more WPAN communications in accordance with a second maximum transmit power that is greater than the first maximum transmit power (block 820). For example, the wireless communication device (e.g., using reception component 902 and/or communication manager 906, depicted in FIG. 9) may receive, in one or more NTN uplink transmission time resources, the one or more WPAN communications in accordance with a second maximum transmit power that is greater than the first maximum transmit power, as described above.

Process 800 may include additional aspects, such as any single aspect or any combination of aspects described below and/or in connection with one or more other processes described elsewhere herein.

In a first aspect, transmitting the one or more WPAN communications in the one or more NTN uplink transmission time resources includes transmitting the one or more WPAN communications based at least in part on a time duration of the one or more NTN uplink transmission time resources satisfying a time duration threshold.

In a second aspect, alone or in combination with the first aspect, process 800 includes receiving an uplink grant that indicates the one or more NTN uplink transmission gap time resources and the one or more NTN uplink transmission time resources.

In a third aspect, alone or in combination with one or more of the first and second aspects, an NTN entity of the wireless communication device indicates, to a controller of the wireless communication device, the one or more NTN uplink transmission gap time resources and the one or more NTN uplink transmission time resources.

In a fourth aspect, alone or in combination with one or more of the first through third aspects, a controller of the wireless communication device indicates, to a WPAN entity of the wireless communication device, a switch to the second maximum transmit power.

In a fifth aspect, alone or in combination with one or more of the first through fourth aspects, process 800 includes transmitting, in one or more NTN downlink transmission time resources, the one or more WPAN communications in accordance with a third maximum transmit power that is less than the second maximum transmit power.

In a sixth aspect, alone or in combination with one or more of the first through fifth aspects, the first maximum transmit power is less than the third maximum transmit power.

In a seventh aspect, alone or in combination with one or more of the first through sixth aspects, the first maximum transmit power is equal to the third maximum transmit power.

In an eighth aspect, alone or in combination with one or more of the first through seventh aspects, the first maximum transmit power is greater than the third maximum transmit power.

In a ninth aspect, alone or in combination with one or more of the first through eighth aspects, process 800 includes receiving an uplink grant that indicates the one or more NTN uplink transmission gap time resources and the one or more NTN uplink transmission time resources, an NTN entity of the wireless communication device indicates, based at least in part on the uplink grant, to a controller of the wireless communication device, the one or more NTN uplink transmission gap time resources and the one or more NTN uplink transmission time resources, and the controller indicates, to a WPAN entity of the wireless communication device, based at least in part on a time duration of the one or more NTN uplink transmission time resources satisfying a time duration threshold, a switch to the second maximum transmit power.

In a tenth aspect, alone or in combination with one or more of the first through ninth aspects, transmitting the one or more WPAN communications in the one or more NTN uplink transmission time resources includes transmitting the one or more WPAN communications at a transmit power associated with an NTN sleep time window of a CDRX or IDRX cycle that is greater than a transmit power associated with an NTN awake time window of the CDRX or IDRX cycle.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a wireless communication device, or a wireless communication device may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node, using the reception component 902 and the transmission component 904. The communication manager 906 may be included in, or implemented via, a processing system of the wireless communication device.

In some aspects, the apparatus 900 may be configured to perform one or more operations described herein in connection with FIGS. 5-7. Additionally, or alternatively, the apparatus 900 may be configured to perform one or more processes described herein, such as process 800 of FIG. 8, or a combination thereof. In some aspects, the apparatus 900 and/or one or more components shown in FIG. 9 may include one or more components of the wireless communication device described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the wireless communication device described above in connection with FIG. 1, such as a radio, one or more RF chains, one or more transceivers, or one or more modems, each of which may in turn be coupled with one or more antennas of the wireless communication device.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the wireless communication device described above in connection with FIG. 1, such as a radio, one or more RF chains, one or more transceivers, or one or more modems, each of which may in turn be coupled with one or more antennas of the wireless communication device described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit, in one or more NTN uplink transmission gap time resources, one or more WPAN communications in accordance with a first maximum transmit power. The transmission component 904 may transmit, in one or more NTN uplink transmission time resources, the one or more WPAN communications in accordance with a second maximum transmit power that is greater than the first maximum transmit power. In some aspects, the reception component 902 may receive an uplink grant that indicates the one or more NTN uplink transmission gap time resources and the one or more NTN uplink transmission time resources. In some aspects, the transmission component 904 may transmit, in one or more NTN downlink transmission time resources, the one or more WPAN communications in accordance with a third maximum transmit power that is less than the second maximum transmit power.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a wireless communication device, comprising: transmitting, in one or more non-terrestrial network (NTN) uplink transmission gap time resources, one or more wireless personal area network (WPAN) communications in accordance with a first maximum transmit power; and transmitting, in one or more NTN uplink transmission time resources, the one or more WPAN communications in accordance with a second maximum transmit power that is greater than the first maximum transmit power.

Aspect 2: The method of Aspect 1, wherein transmitting the one or more WPAN communications in the one or more NTN uplink transmission time resources includes transmitting the one or more WPAN communications based at least in part on a time duration of the one or more NTN uplink transmission time resources satisfying a time duration threshold.

Aspect 3: The method of any of Aspects 1-2, further comprising: receiving an uplink grant that indicates the one or more NTN uplink transmission gap time resources and the one or more NTN uplink transmission time resources.

Aspect 4: The method of any of Aspects 1-3, wherein an NTN entity of the wireless communication device indicates, to a controller of the wireless communication device, the one or more NTN uplink transmission gap time resources and the one or more NTN uplink transmission time resources.

Aspect 5: The method of any of Aspects 1-4, wherein a controller of the wireless communication device indicates, to a WPAN entity of the wireless communication device, a switch to the second maximum transmit power.

Aspect 6: The method of any of Aspects 1-5, further comprising: transmitting, in one or more NTN downlink transmission time resources, the one or more WPAN communications in accordance with a third maximum transmit power that is less than the second maximum transmit power.

Aspect 7: The method of Aspect 6, wherein the first maximum transmit power is less than the third maximum transmit power.

Aspect 8: The method of Aspect 6, wherein the first maximum transmit power is equal to the third maximum transmit power.

Aspect 9: The method of Aspect 6, wherein the first maximum transmit power is greater than the third maximum transmit power.

Aspect 10: The method of any of Aspects 1-9, further comprising: receiving an uplink grant that indicates the one or more NTN uplink transmission gap time resources and the one or more NTN uplink transmission time resources, wherein an NTN entity of the wireless communication device indicates, based at least in part on the uplink grant, to a controller of the wireless communication device, the one or more NTN uplink transmission gap time resources and the one or more NTN uplink transmission time resources, and wherein the controller indicates, to a WPAN entity of the wireless communication device, based at least in part on a time duration of the one or more NTN uplink transmission time resources satisfying a time duration threshold, a switch to the second maximum transmit power.

Aspect 11: The method of any of Aspects 1-10, wherein transmitting the one or more WPAN communications in the one or more NTN uplink transmission time resources includes transmitting the one or more WPAN communications at a transmit power associated with an NTN sleep time window of a CDRX or IDRX cycle that is greater than a transmit power associated with an NTN awake time window of the CDRX or IDRX cycle.

Aspect 12: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-11.

Aspect 13: An apparatus for wireless communication at a device, the apparatus comprising one or more memories and one or more processors coupled to the one or more memories, the one or more processors configured to cause the device to perform the method of one or more of Aspects 1-11.

Aspect 14: An apparatus for wireless communication, the apparatus comprising at least one means for performing the method of one or more of Aspects 1-11.

Aspect 15: A non-transitory computer-readable medium storing code for wireless communication, the code comprising instructions executable by one or more processors to perform the method of one or more of Aspects 1-11.

Aspect 16: A non-transitory computer-readable medium storing a set of instructions for wireless communication, the set of instructions comprising one or more instructions that, when executed by one or more processors of a device, cause the device to perform the method of one or more of Aspects 1-11.

Aspect 17: A device for wireless communication, the device comprising a processing system that includes one or more processors and one or more memories coupled with the one or more processors, the processing system configured to cause the device to perform the method of one or more of Aspects 1-11.

Aspect 18: An apparatus for wireless communication at a device, the apparatus comprising one or more memories and one or more processors coupled to the one or more memories, the one or more processors individually or collectively configured to cause the device to perform the method of one or more of Aspects 1-11.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, the phrase “based on” is intended to mean “based at least in part on” or “based on or otherwise in association with” unless explicitly stated otherwise.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a wireless communication device, comprising:
one or more memories; and
one or more processors coupled to the one or more memories, the one or more processors individually or collectively configured to cause the wireless communication device to:
transmit, in one or more non-terrestrial network (NTN) uplink transmission gap time resources, one or more wireless personal area network (WPAN) communications in accordance with a first maximum transmit power; and
transmit, in one or more NTN uplink transmission time resources, the one or more WPAN communications in accordance with a second maximum transmit power that is greater than the first maximum transmit power.

2. The apparatus of claim 1, wherein the one or more processors, to cause the wireless communication device to transmit the one or more WPAN communications in the one or more NTN uplink transmission time resources, are configured to cause the wireless communication device to transmit the one or more WPAN communications based at least in part on a time duration of the one or more NTN uplink transmission time resources satisfying a time duration threshold.

3. The apparatus of claim 1, wherein the one or more processors are individually or collectively further configured to cause the wireless communication device to:
receive an uplink grant that indicates the one or more NTN uplink transmission gap time resources and the one or more NTN uplink transmission time resources.

4. The apparatus of claim 1, wherein an NTN entity of the wireless communication device indicates, to a controller of the wireless communication device, the one or more NTN uplink transmission gap time resources and the one or more NTN uplink transmission time resources.

5. The apparatus of claim 1, wherein a controller of the wireless communication device indicates, to a WPAN entity of the wireless communication device, a switch to the second maximum transmit power.

6. The apparatus of claim 1, wherein the one or more processors are individually or collectively further configured to cause the wireless communication device to:
transmit, in one or more NTN downlink transmission time resources, the one or more WPAN communications in accordance with a third maximum transmit power that is less than the second maximum transmit power.

7. The apparatus of claim 6, wherein the first maximum transmit power is less than the third maximum transmit power.

8. The apparatus of claim 6, wherein the first maximum transmit power is equal to the third maximum transmit power.

9. The apparatus of claim 6, wherein the first maximum transmit power is greater than the third maximum transmit power.

10. The apparatus of claim 1, wherein the one or more processors are further configured to cause the wireless communication device to:
receive an uplink grant that indicates the one or more NTN uplink transmission gap time resources and the one or more NTN uplink transmission time resources, wherein an NTN entity of the wireless communication device indicates, based at least in part on the uplink grant, to a controller of the wireless communication device, the one or more NTN uplink transmission gap time resources and the one or more NTN uplink transmission time resources, and wherein the controller indicates, to a WPAN entity of the wireless communication device, based at least in part on a time duration of the one or more NTN uplink transmission time resources satisfying a time duration threshold, a switch to the second maximum transmit power.

11. The apparatus of claim 1, wherein the one or more processors, to cause the wireless communication device to transmit the one or more WPAN communications in the one or more NTN uplink transmission time resources, are configured to cause the wireless communication device to transmit the one or more WPAN communications at a transmit power associated with an NTN sleep time window of a connected mode discontinuous reception (CDRX) or idle mode discontinuous reception (IDRX) cycle that is greater than a transmit power associated with an NTN awake time window of the CDRX or IDRX cycle.

12. A method of wireless communication performed by a wireless communication device, comprising:
transmitting, in one or more non-terrestrial network (NTN) uplink transmission gap time resources, one or more wireless personal area network (WPAN) communications in accordance with a first maximum transmit power; and
transmitting, in one or more NTN uplink transmission time resources, the one or more WPAN communications in accordance with a second maximum transmit power that is greater than the first maximum transmit power.

13. The method of claim 12, wherein transmitting the one or more WPAN communications in the one or more NTN uplink transmission time resources includes transmitting the one or more WPAN communications based at least in part on a time duration of the one or more NTN uplink transmission time resources satisfying a time duration threshold.

14. The method of claim 12, further comprising:
receiving an uplink grant that indicates the one or more NTN uplink transmission gap time resources and the one or more NTN uplink transmission time resources.

15. The method of claim 12, wherein an NTN entity of the wireless communication device indicates, to a controller of the wireless communication device, the one or more NTN uplink transmission gap time resources and the one or more NTN uplink transmission time resources.

16. The method of claim 12, wherein a controller of the wireless communication device indicates, to a WPAN entity of the wireless communication device, a switch to the second maximum transmit power.

17. The method of claim 12, further comprising:
transmitting, in one or more NTN downlink transmission time resources, the one or more WPAN communications in accordance with a third maximum transmit power that is less than the second maximum transmit power.

18. An apparatus for wireless communication, comprising:
means for transmitting, in one or more non-terrestrial network (NTN) uplink transmission gap time resources, one or more wireless personal area network (WPAN) communications in accordance with a first maximum transmit power; and
means for transmitting, in one or more NTN uplink transmission time resources, the one or more WPAN communications in accordance with a second maximum transmit power that is greater than the first maximum transmit power.

19. The apparatus of claim 18, wherein the means for transmitting the one or more WPAN communications in the one or more NTN uplink transmission time resources includes means for transmitting the one or more WPAN communications based at least in part on a time duration of the one or more NTN uplink transmission time resources satisfying a time duration threshold.

20. The apparatus of claim 18, further comprising:
means for receiving an uplink grant that indicates the one or more NTN uplink transmission gap time resources and the one or more NTN uplink transmission time resources.
